(19) United States
(12) Patent Application Publication
(10) Pub. No.: US 2026/0211638 A1
(43) Pub. Date: Jul. 23, 2026

(54) EVALUATING LARGE LANGUAGE MODEL GENERATED CODE USING APPLICATION SERVER CONTEXT

(71) Applicant: SAP SE, Walldorf (DE)

(72) Inventors: Manuel Berning, Dielheim (DE); Niklas Kemper, Leimen (DE); Mikhail Yakovlev, Karlsdorf-Neuthard (DE); Marco Haupt, Biblis (DE); Minh-Khanh Do, Leimen (DE)

(21) Appl. No.: 19/035,068

(22) Filed: Jan. 23, 2025

(51) Int. Cl. G06F 8/35; G06F 8/41; G06F 11/34

(52) U.S. Cl. CPC G06F 8/35; G06F 8/42; G06F 11/3428

(57) ABSTRACT

The present disclosure involves systems, software, and computer implemented methods for evaluating code generation. A method includes identifying a code artifact for a benchmark task. A portion of code for the benchmark task is determined in a first copy of the artifact. A second copy of the artifact is automatically generated by replacing, in the first copy of the artifact, the portion of code with a fill-in marker. A prompt and at least a portion of the second copy of the artifact are provided to a model. The prompt instructs the model to generate code to replace the fill-in marker. A third copy of the artifact is automatically generated by replacing, in the second copy of the artifact, the fill-in marker with model-generated code. The model-generated code is evaluated by executing an executable version of the third copy of the artifact.

### BACKGROUND

Generative artificial intelligence (AI) (genAI) approaches can use generative (e.g., large language) models to generate one or more outputs in response to a query. A large language model (LLM) can learn, for example, from patterns and structures in training data. A trained LLM can then generate a response based on learned patterns.

### SUMMARY

The present disclosure describes evaluating large language model generated code using application server context.

In an implementation, a computer-implemented method includes identifying a first code artifact for a first artificial intelligence (AI) benchmark task. An executable version of the first code artifact is configured to run in a first execution context. A first portion of code for the first AI benchmark task is determined in a first copy of the first code artifact. A second copy of the first code artifact is automatically generated by automatically replacing, in the first copy of the first code artifact, the first portion of code for the first AI benchmark task with a first fill-in marker for AI code generation. A first prompt and at least a portion of the second copy of the first code artifact are provided to a first AI model. The first prompt instructs the first AI model to generate code to replace the first fill-in marker. First model-generated code is received from the first AI model. A third copy of the first code artifact is automatically generated by automatically replacing, in the second copy of the first code artifact, the first fill-in marker with the first model-generated code. Code generation of the first AI model is automatically evaluated by automatically evaluating the third copy of the first code artifact, including executing an executable version of the third copy of the first code artifact in a second execution context that is equivalent to the first execution context.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, artificial intelligence (AI) code generation can be automatically evaluated. Second, AI-generated code can be evaluated using a context equivalent to a context used for original reference implementations. Third, automatically evaluated code can include global variables and global methods that are not possible in single assert statement environments. Fourth, AI benchmark tasks can be created in a code artifact through simple insertion of predefined tags. Fifth, AI code generation metrics can be automatically generated for comparison of different AI models. Sixth, multiple AI benchmark tasks can be created and evaluated for a given code artifact.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example of a system 100 for evaluating large language model generated code using application server context, according to an implementation of the present disclosure.

FIG. 2 is a code listing of an example of code of a class with a user-defined task, according to an implementation of the present disclosure.

FIG. 3 is a code listing of an example of code of a class with multiple user-defined tasks, according to an implementation of the present disclosure.

FIG. 4 is a code listing of an example of code of a first class for unit testing of a second class, according to an implementation of the present disclosure.

FIG. 5 is a code listing of an example of code of a class clone, according to an implementation of the present disclosure.

FIG. 6 is a code listing of an example of code of an executable class clone, according to an implementation of the present disclosure.

FIG. 7 is a block diagram illustrating an example of a model evaluation system, according to an implementation of the present disclosure.

FIG. 8 is a flowchart illustrating an example of a computer-implemented method for evaluating large language model generated code using application server context, according to an implementation of the present disclosure.

FIG. 9 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes evaluating LLM (large language model) generated code using application server context and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

An evaluation system can evaluate various LLMs for tasks such as programming code completion (e.g., code generation). However, challenges can exist when evaluating generated code for applications on an application server. For example, an isolated execution of the generated code is generally not sufficient for proper evaluation of the generated code due to lack of representative context of an original code artifact (e.g., class or program) for which the generated code is being evaluated. A representative context for the code artifact can include representative data, objects, and functionality that are dependencies of the code artifact being executed.

To provide for proper evaluation of LLM-generated code, a model evaluation system can be used that enables execution and evaluation of LLM-generated code with an original context of original code artifacts into which LLM-generated code has been inserted. With the model evaluation system, dependencies of the code artifact are usable during benchmark execution. Benchmark tasks can be generated for the model evaluation system that expect that the LLM-generated code uses the original context of the code artifact. Benchmark tasks can be created within an application server that has context equivalent to context in which the original code artifact is executed rather than in a separate pipeline, thereby enabling generated code execution and evaluation using context and dependencies of original code artifacts from which the benchmark tasks are created. Accordingly, LLM-generated code of different models can be properly evaluated and compared to determine which LLM generates best code in a realistic context of the application server (e.g., where best code can be based on various metrics, such as successful syntax check and unit test pass rates, as described in following paragraphs.

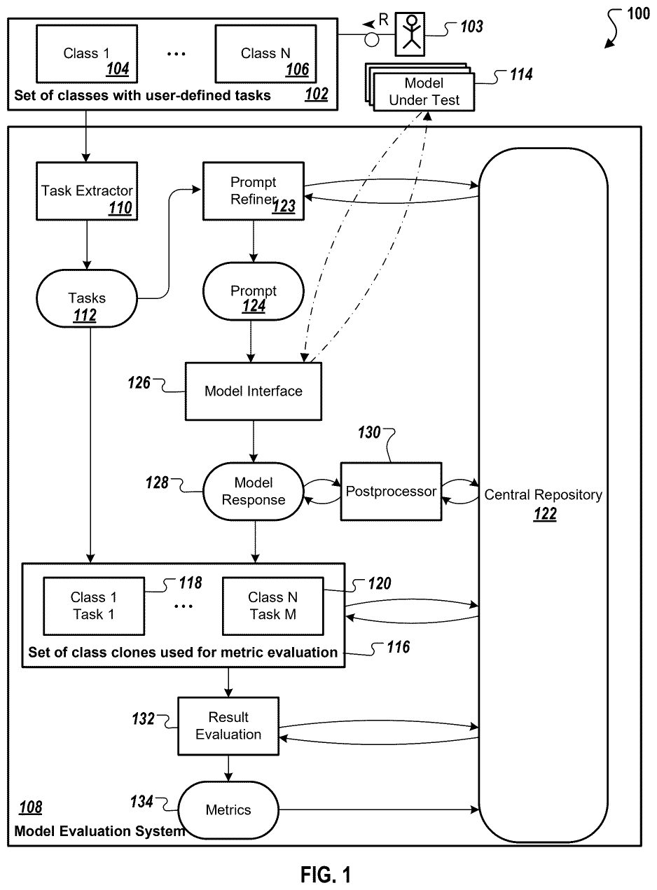

FIG. 1 is a block diagram illustrating an example of a system 100 for evaluating large language model generated code using application server context, according to an implementation of the present disclosure. The system 100 includes a set of classes 102 with user-defined tasks that have been defined, for example, by a user 103 (or by an automated process). Although classes are described, the system 100 can be used for other types of code artifacts, such as programs, procedures, functions, etc. The set of classes 102 can be original classes copied from a productive system, for example.

The set of classes 102 includes one or more classes. As illustrated, the set of classes 102 includes a class one 104, a class N 106, and possibly other classes.

Each class in the set of classes 102 can include solution tags that demark the user-defined tasks. The solution tags can be special code comments (e.g., solution-start, solution-end code comments) that have a specific structure. In some implementations, each solution-start and solution-end comment marker has a unique identifier (e.g., unique for at least the set of classes 102 for which a benchmark test will be executed. The solution tags can mark a point in a class at which an LLM is to generate code. In some cases, the solution tags surround a block of code in the original class where the block of code is a reference implementation.

The reference implementation may have various dependencies. For example, the reference implementation may include code to query various tables or other data objects, invoke one or more APIs (Application Programming Interfaces), etc. LLM-generated code may also have similar dependencies. Thus, as described in following paragraphs, execution of LLM-generated code can be performed in a model evaluation system 108 in which necessary context and dependencies are available.

The classes in the set of classes 102 can each have one or more unit tests for each reference implementation. Copies of those unit tests can be used to test LLM-generated code in the model evaluation system 108, as described in following paragraphs.

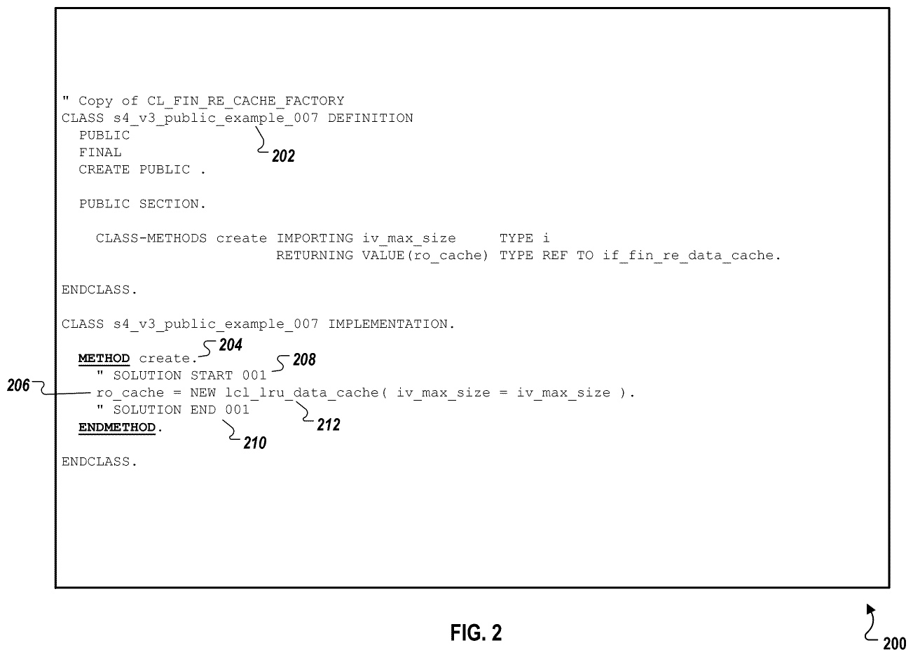

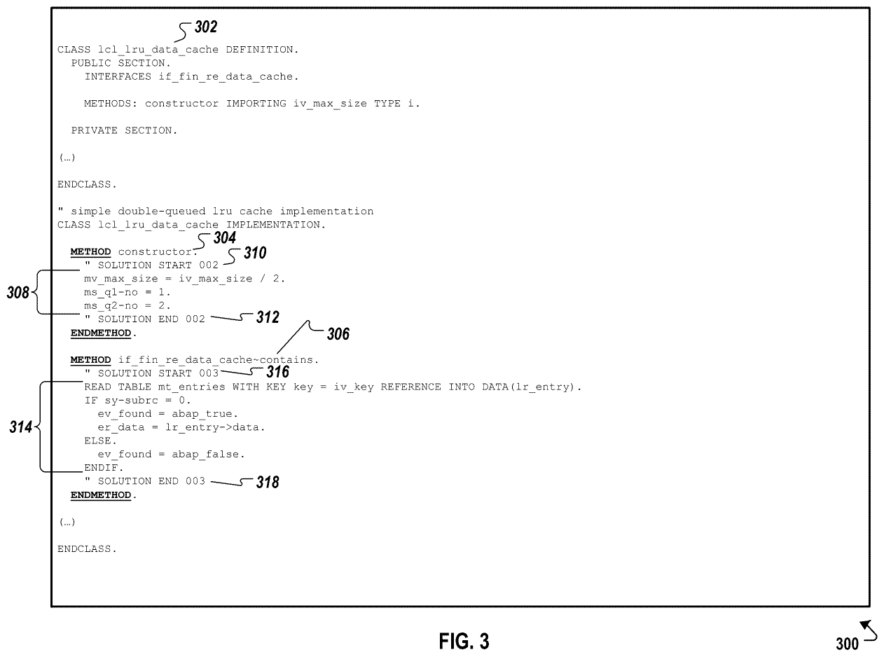

FIG. 2 is a code listing of an example of code 200 of a class 202 with a user-defined task, according to an implementation of the present disclosure. The class 202 is a “s4_v3_public_example_007” class and can be example of one of the classes in the set of classes 102 of FIG. 1. A create method 204 has a reference implementation line of code 206 surrounded by a solution-start tag 208 and a solution-end tag 210. The solution-start tag 208 and the solution-end tag 210 each have a solution identifier of “001.” The reference implementation line of code 206 is code for creating an instance of a “lcl_lru_data_cache” class 212. Example code for the “lcl_lru_data_cache” class 212 is shown in FIG. 3.

FIG. 3 is a code listing of an example of code 300 of a class 302 with multiple user-defined tasks, according to an implementation of the present disclosure. The class 302 is the “lcl_lru_data_cache” class referenced in the code 200 of FIG. 2. The class 302 can be example of one of the classes in the set of classes 102 of FIG. 1. The class 302 includes a constructor method 304 and an “if_fin_re_data_cache~contains” method 306.

The constructor method 304 includes a reference implementation block of code 308 surrounded by a solution-start tag 310 and a solution-end tag 312 which each have a solution identifier of “002.” Similarly, the “if_fin_re_data_cache~contains” method 306 includes a reference implementation block of code 314 surrounded by a solution-start tag 316 and a solution-end tag 318 which each have a solution identifier of “002.” The respective solution-start and solution-end tag pairs in FIG. 3 (and FIG. 2) mark points in respective classes at which a user has identified solutions, or tasks. As described in following paragraphs, respective solution blocks of code can be replaced with a fill-in marker and code with a fill-in marker can be provided to a model with a prompt instructing the model to generate code at that point as a replacement for the fill-in marker. Model-generated code can be evaluated, at least in part, using a unit test of the class.

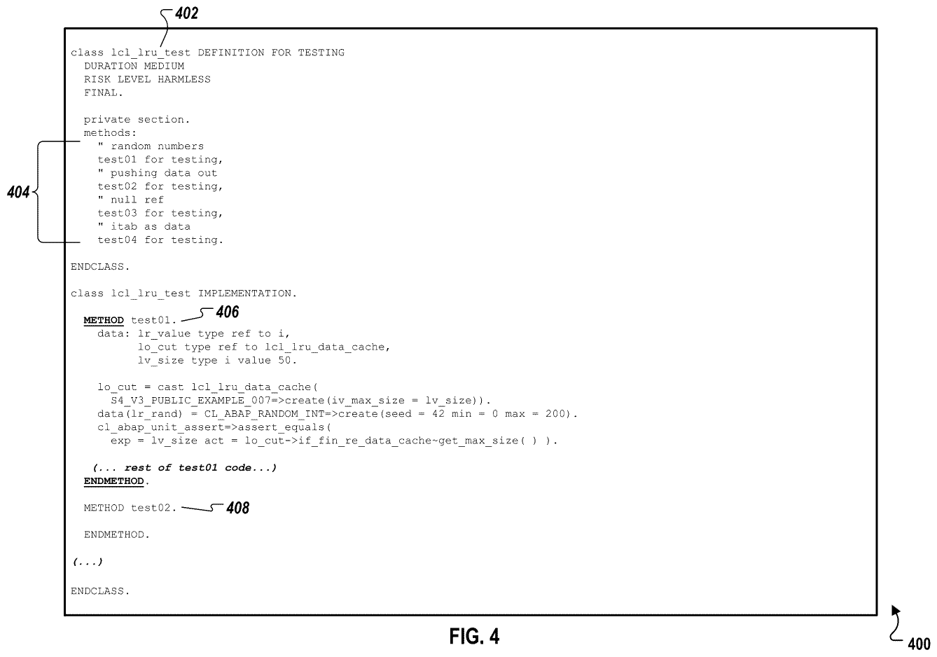

FIG. 4 is a code listing 400 of an example of code of a first class 402 for unit testing of a second class, according to an implementation of the present disclosure. The first class 402 is a “lcl_lru_test” class that is configured for unit testing of the class 302 (e.g., the “lcl_lru_data_cache” class referenced in the code 300 of FIG. 3). A definition of the first class 402 includes a specification 404 of a set of test methods (e.g., test methods “test01,” “test02,” “test03,” and “test04”). An implementation portion of the code listing 400 includes implementations 406 and 408 of the “test01” and “test02” test methods, respectively. Implementations of the “test03” and “test04” methods have been omitted for brevity. The test methods of the first class 402 can be configured to test the reference implementation of the second class (e.g., the class 302) as well as to test code generated by prompted LLMs, using benchmark tasks and class clones, as described in following paragraphs.

Referring again to FIG. 1, the classes in the set of classes 102 can be used for model evaluation in the model evaluation system 108. The model evaluation system 108 can be, for example, a dedicated server (e.g., application server) that is configured to run benchmark tests, using application sever context, but in an environment that can be isolated from a production environment. The model evaluation system 108 can be isolated from the production environment to protect the production environment against potentially malicious code generated by a particular model, for example. The model evaluation system 108 can be a particular instance of an application server, at a particular version, perhaps configured for a particular customer with customer extensions, etc., to correspond to and be compatible with the classes in the set of classes 102 for which benchmark tests are executed.

A task extractor 110 can extract, from the set of classes 102, a set of tasks 112. A task can be identified, for example, for each solution included in the set of classes 102. A class may have more than one solution, for example. The task extractor 110 can iterate over the classes in the set of classes 102 and identify, for each class, each set of solution tags in a given class.

The task extractor 110 (or another component of the model evaluation system 108) can create a separate new class for each identified task. The task extractor 110 can, for example, for each task, copy, into the new class, the code from the particular class in the set of classes 102 that corresponds to the task, remove solution tags for any task of the class other than the task, and replace the solution tags for the task and the block of code in the class that lies between the solution tags for the task with a fill-in marker. A model-under-test 114 can be trained to understand, identify and replace the fill-in marker with generated code, for example.

The new classes can be stored as a set of class clones 116 to be used for model evaluation of the model-under-test 114. Each class clone in the set of class clones 116 corresponds to a particular class of the set of classes 102 and a particular task. For example, the set of class clones 116 includes a class clone 118 which is a clone of a class one task (e.g., the class 104) configured for a first task of the class 104. The set of class clones 116 also includes, among possibly other class clones, a class clone 120 which is a clone of a class N class (e.g., the class 106) configured for a task M of the class N class. The set of class clones 116 can be stored in a central repository 122 of the model evaluation system 108. Each class clone may have a programmatically generated and unique name that is not in conflict with names of the classes in the set of classes 102 or any other classes that exist in the model evaluation system 108.

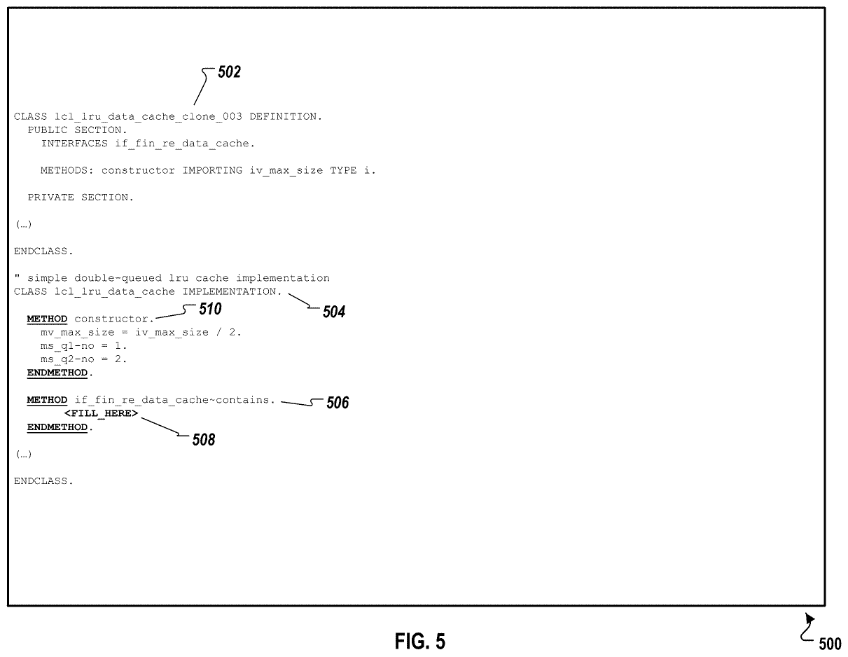

FIG. 5 is a code listing 500 of an example of code of a class clone 502, according to an implementation of the present disclosure. The class clone 502 is a “lcl_lru_data_cache_clone_003” class and is a clone of the “lcl_lru_data_cache” class (e.g., the class 302 of FIG. 3). The class clone 502 corresponds to the class 302 and also the solution “003” of the class 302. The name of the class clone 502 can be a combination of the name of class 302, an indication of a particular solution of the class 302 (e.g., solution “003”), and possibly other text (e.g., “_clone_”). Other class clone naming approaches can be used to distinguish the class clone 502 name from other classes, including the class 302. The class clone 502 can be created by the task extractor 110 of FIG. 1 and can be included in the set of class clones 116. The set of class clones 116 can also include a different class clone for the solution “002” of the class 302 and a class clone of the class 202 of FIG. 2 (for the solution “001” of the class 202).

An implementation portion 504 of the code listing 500 includes a portion 506 for an “if_fin_re_data_cache~contains” method. The portion 506 for the “if_fin_re_data_cache~contains” method includes a fill-in marker 508. In this example, after creating the class clone 502 as a copy of the class 302, the task extractor 110 has replaced the solution start and end tags for solution “003” and the included reference implementation with the fill-in marker 508. The task extractor 110 has also removed solution tags for solution “002” from a constructor method 510. The class clone 502 can be provided (with a prompt) to a model under test to prompt the model to replace the fill-in marker 508 with generated code.

Referring again to FIG. 1, after the class clones in the set of class clones 116 have been generated, a prompt refiner 123 can, for a given class clone in the set of class clones 116, generate a prompt 124 that is configured to prompt the model-under-test 114 to generate code for the task corresponding to the class clone. The prompt 124 can either include the class clone and/or include information from the class clone. The prompt 124 can describe a role of the model-under-test 114 (for example, that the model should act as an experienced developer) and a code-completion task to complete of generating code to replace the fill-in marker in the class clone (e.g., the fill-in marker 508).

The model evaluation system 108 can use a model interface 126 (e.g., an API that enables sending and receiving messages to/from the model-under-test 114, respectively) to provide the prompt 124 to the model-under-test 114. The model evaluation system 108 can receive, using the model interface 126, a model response 128 from the model-under-test 114. The model response 128 can include code generated by the model-under-test 114 in response to the prompt 124.

A post-processor 130 can extract generated code from the model response 128. The post-processor can use the extracted code to adjust the class clone for which the code was generated by replacing the fill-in marker in the class code with the generated code extracted from the model response 128. Accordingly, if the generated code generated by the model-under-test 114 does not include any syntax errors, the adjusted class clone can be an executable class which can be further evaluated. The adjusted class clone can be stored in the central repository 122.

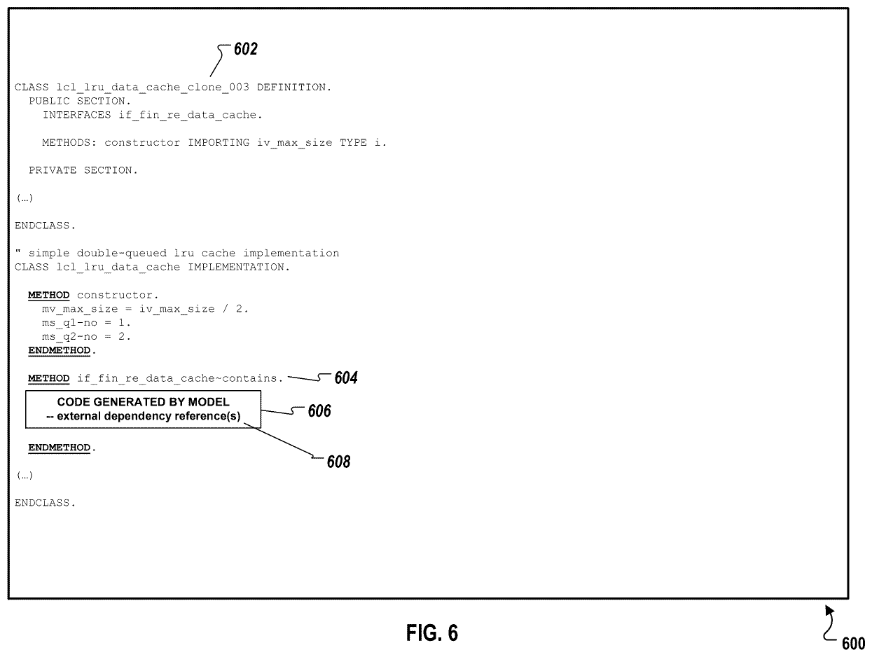

FIG. 6 is a code listing 600 of an example of code of an executable class clone, according to an implementation of the present disclosure. A class 602 is an adjusted version of the class clone 502 that has been adjusted by replacing the fill-in marker 508 with model-generated code. For example, a method 604 now includes a block of code 606 (e.g., illustrated in FIG. 6 as a box of generated code) rather than the fill-in marker 508. The block of code 606 can include code (e.g., external object references 608) that relies on external dependencies that are external to the class 602.

Referring again to FIG. 1, a result evaluation engine 132 can evaluate the code generation of the model-under-test 114. For example, the result evaluation engine 132 can evaluate the model response 128 using the corresponding adjusted class clone by using a multi-tiered evaluation process that includes a scan test, a syntax check, and unit test execution. In the scan test, the result evaluation engine 132 can provide the adjusted class clone to a scanner. The scanner can attempt to serialize the adjusted class clone into a format that is storable in the central repository 122. The scanner can provide a scan success or fail indicator to the result evaluation engine 132.

If the scan test passes, the result evaluation engine 132 can provide the adjusted class clone to a syntax checker (e.g., of a compiler). The syntax checker can check the syntax of the adjusted class clone, with the syntax check including syntax checking of code in the model response 128 that is now included in the adjusted class clone. The syntax checker can provide a syntax check success or fail indicator to the result evaluation engine 132.

If the syntax check passes, the result evaluation engine 132 can proceed to execute unit test(s) associated with the adjusted class clone. For instance, for the adjusted class clone of FIG. 6, the model evaluation engine can execute the unit tests illustrated in FIG. 4. The result evaluation engine 132 can execute unit test(s) to determine whether desired functionalities are available with the model generated code or whether the adjusted class clone no longer functions as desired. The result evaluation engine 132 can determine unit test execution results for the adjusted class clone, to determine whether the adjusted class clone provides desired functionality, rather than analyzing exact code specifics of a particular implementation generated by the model-under-test. By executing the unit tests for an adjusted class clone on the model evaluation system 108, the result evaluation engine 132 can realize an execution that has a same context (e.g., availability of same or similar external dependencies) as would execution of the original corresponding class in the set of classes 102.

In implementations in which generated code is ABAP (Advanced Business Application Programming) code, provided by SAP SE of Walldorf, Germany, the result evaluation engine 132 can address ABAP-specific execution aspects during the execution of unit tests for certain features of the ABAP language. For example, for the evaluation of objects from an ABAP RAP (Restful Application Programming) framework, a behavior definition can be processed by the model evaluation engine for each execution of a unit test and redirected to the adjusted class clone to be tested that includes the implementation of the behavior definition. As another example, for evaluation of tasks that use ABAP for Cloud Development language features, the result evaluation engine 132 can add newly created classes to a transport request that refers to the original package from which the classes originate so that the new classes can be executed (e.g., since a limitation may exist regarding invoking code outside of a package).

The result evaluation engine 132 can store scan, syntax check, and unit test results for a particular adjusted class clone and particular model-under-test 114 in or as metrics 134 (which can reside in the central repository 122). The model evaluation system 108 can, for a given model-under-test, perform model prompting, model response receiving, adjusted class clone generation, and adjusted class clone evaluation for each task (e.g., each class clone) in the set of class clones 116. The result evaluation engine 132 can then determine, in or as the metrics 134, aggregate metrics for the given model-under-test 114. Aggregate metrics for a given model-under-test 114 can include a scan success rate, a syntax check success rate, and a unit test success rate.

The result evaluation engine 132 can repeat model prompting, model response receiving, adjusted class clone generation, and adjusted class clone evaluation for each task (e.g., each class clone) in the set of class clones 116 for each of multiple models or at multiple points in time to evaluate an effect of changing dependencies/context on model performance. The result evaluation engine can determine, in or as the metrics 134, cross-model aggregate metrics, such as average scan success rate, average syntax check success rate, and average unit test success rate, as well as comparisons of metrics for a given model to the cross-model aggregate metrics. In some implementations, task-specific, class-specific, and/or unit test specific metrics can be generated across tasks, classes, and models, since there may be, for example, several tasks per class, several unit tests for a single class/task that check different aspects, etc.

When performing task processing for a given model and/or across models, the model evaluation system 108 may perform some processing in parallel. For instance, the model evaluation system 108 and specific portions (e.g., the result evaluation engine 132) can use a framework that parallelizes the execution of individual tasks with the help, for example, of daemons on the model evaluation system 108.

The result evaluation engine 132 can generate, in or as the metrics 134, other metrics that compare various models based on various criteria. For example, the result evaluation engine 132 can generate a ranking of models based on highest overall unit test success rate. The result evaluation engine 132 (or more generally the model evaluation system 108) can generate and provide a dashboard that enables a user to view various metrics, side by side views of a model response 128 and a corresponding reference implementation, etc.

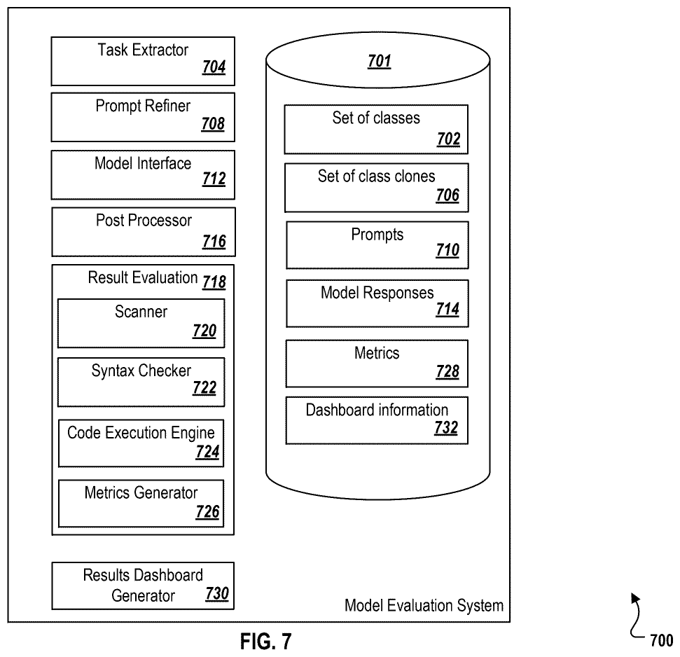

FIG. 7 is a block diagram illustrating an example of a model evaluation system 700, according to an implementation of the present disclosure. The model evaluation system 700 includes, in a repository 701, a set of classes 702. The set of classes 702 can include copies of classes (or other types of code artifacts) for which AI benchmark tasks are desired, for example. Classes in the set of classes 702 can each include task (e.g., solution) tags that demark the benchmark tasks. The solution tags can be special code comments, for example. The classes in the set of classes 702 can each have one or more unit tests for each benchmark test. The classes in the set of classes 702 can be used for model evaluation in the model evaluation system 700.

A task extractor 704 can identify, from the set of classes 702, a set of tasks. A task can be identified, for example, for each solution included in the set of classes 702. A class may have more than one solution, for example. The task extractor 704 can iterate over the classes in the set of classes 702 and identify, for each class, each set of solution tags in a given class.

The task extractor 704 can create, in a set of class clones 706, a separate new class for each identified task. The task extractor 704 can, for example, for each task, copy, into a class clone, the code from the particular class in the set of classes 702 that corresponds to the task, remove solution tags for any task of the class other than the task, and replace the solution tags for the task and the block of code in the class that lies between the solution tags for the task with a fill-in marker as a marker for AI code generation. Each class clone may have a programmatically generated and unique name that is not in conflict with names of the classes in the set of classes 702 or any other classes that exist in the model evaluation system 700.

After the class clones in the set of class clones 706 have been generated by the task extractor 704, a prompt refiner 708 can, for a given class clone in the set of class clones 706, generate a prompt (e.g., in a prompts repository 710) that is configured to prompt a given AI model to generate code for the task corresponding to the class clone.

The model evaluation system 700 can provide, using a model interface 712 (e.g., an API that enables sending and receiving messages to/from AI models) the prompt and corresponding information from the class clone that includes a given benchmark task to the AI model. The AI model can generate code for the benchmark task in response to the prompt. The model evaluation system 700 can receive, using the model interface 712, a model response from the AI model. The model response can be stored in model responses 714. A post-processor 716 can extract generated code from the model response and use the extracted code to adjust the class clone for which the code was generated by replacing the fill-in marker in the class code with the generated code extracted from the model response.

A result evaluation engine 718 can evaluate the code generation of the AI model by using a multi-tiered evaluation process that includes a scan test, a syntax check, and unit test execution. In the scan test, a scanner 720 can attempt to serialize the adjusted class clone (e.g., into a serialized stream). If the scan test passes, a syntax checker 722 can check the syntax of the adjusted class clone, with the syntax check including syntax checking of code in the model response that is now included in the adjusted class clone.

If the syntax check passes, a code execution engine 724 can proceed to execute unit test(s) associated with the adjusted class clone. The code execution engine 724 can execute unit test(s) to determine whether desired functionalities are available with the model-generated code or whether the adjusted class clone no longer functions as desired. The code execution engine 724 can execute the unit tests (e.g., resulting in invocations of the AI generated code) using an execution context that is equivalent to an execution context used for executing code for the original code artifact. For example, the equivalent context can have an availability of same or similar external dependencies.

Similar processing for other benchmark classes can be performed for the AI model and then, in turn, for other AI models. A metrics generator 726 can generate various metrics 728 for a given AI model and across AI models for model comparison, such as scan success rates, syntax check success rates, and unit test success rates. A dashboard generator 730 can generate dashboard information 732 that can be used to generate a results dashboard for user analysis of AI benchmark results. The dashboard can enable a user to view various metrics, side by side views of a model response and a corresponding original (e.g., reference) implementation, etc.

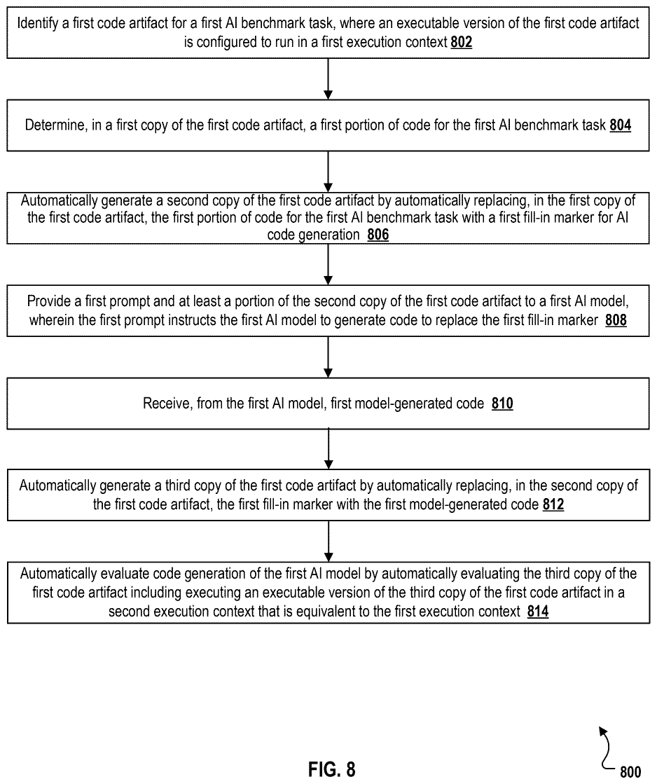

FIG. 8 is a flowchart illustrating an example of a computer-implemented method 800 for evaluating large language model generated code using application server context, according to an implementation of the present disclosure. For clarity of presentation, the description that follows generally describes method 800 in the context of the other figures in this description. However, it will be understood that method 800 can be performed, for example, by any system, environment, software, and hardware, or a combination of systems, environments, software, and hardware, as appropriate. In some implementations, various steps of method 800 can be run in parallel, in combination, in loops, or in any order.

At 802, a first code artifact for a first artificial intelligence (AI) benchmark task is identified. An executable version of the first code artifact is configured to run in a first execution context. The first code artifact can be a class (e.g., ABAP class), a program (e.g., ABAP program), or some other type of code artifact. From 802, method 800 proceeds to 804.

At 804, a first portion of code for the first AI benchmark task is determined in a first copy of the first code artifact. The first portion of code for the first AI benchmark task can be delimited by a predetermined benchmark task start marker and a predetermined benchmark task end marker. From 804, method 800 proceeds to 806.

At 806, a second copy of the first code artifact is automatically generated by automatically replacing, in the first copy of the first code artifact, the first portion of code for the first AI benchmark task with a first fill-in marker for AI code generation. The first portion of code for the first AI benchmark task can be a reference implementation for the first AI benchmark task. From 806, method 800 proceeds to 808.

At 808, a first prompt and at least a portion of the second copy of the first code artifact are provided to a first AI model. The first prompt instructs the first AI model to generate code to replace the first fill-in marker. From 808, method 800 proceeds to 810.

At 810, first model-generated code is received from the first AI model. In some examples, the reference implementation and the first model-generated code each include a reference to a same external resource. From 810, method 800 proceeds to 812.

At 812, a third copy of the first code artifact is automatically generated by automatically replacing, in the second copy of the first code artifact, the first fill-in marker with the first model-generated code. From 812, method 800 proceeds to 814.

At 814, code generation of the first AI model is automatically evaluated by automatically evaluating the third copy of the first code artifact, including executing an executable version of the third copy of the first code artifact in a second execution context that is equivalent to the first execution context. The first execution context and the second execution context can each include an availability of a same set of external resources that are external to the first code artifact and are available to be used by the executable version of the first code artifact and the executable version of the third copy of the first code artifact. Automatically evaluating the third copy of the first code artifact can include determining whether the third copy of the first code artifact can be successfully serialized, performing a syntax check of the third copy of the first code artifact and determining whether the syntax check is successful, and performing one or more unit tests. For example, executing the executable version of the third copy of the first code artifact in the second execution context can include identifying at least one unit test for the first AI benchmark task and executing each identified unit test for the first AI benchmark task. Executing each unit test can include executing an executable version of the first model-generated code and evaluating the execution of the executable version of the first model-generated code. After 814, method 800 can stop.

The method 800 can include other steps. For example, the method 800 can include providing information for other code artifact copies for other AI benchmark tasks to the first AI model and automatically evaluating code generated by the first AI model for the other AI benchmark tasks. AI code generation metrics can be determined for the first AI model based on automatic evaluation of the third copy of the first code artifact and automatic evaluation of the code generated by the first AI model for the other AI benchmark tasks. Information for the third copy of the first code artifact and for other code artifact copies for the other benchmark tasks can also be provided to one or more other AI models. Code generated by the one or more other AI models can be automatically evaluated. Cross-model code generation metrics can be determined for the first AI model and the one or more other AI models. A dashboard can be generated that presents code generation metrics for a given AI model, the cross-model code generation metrics, and a view that includes, for a given AI benchmark task and a given AI model, generated code generated by the AI model and a reference implementation for the given AI benchmark task.

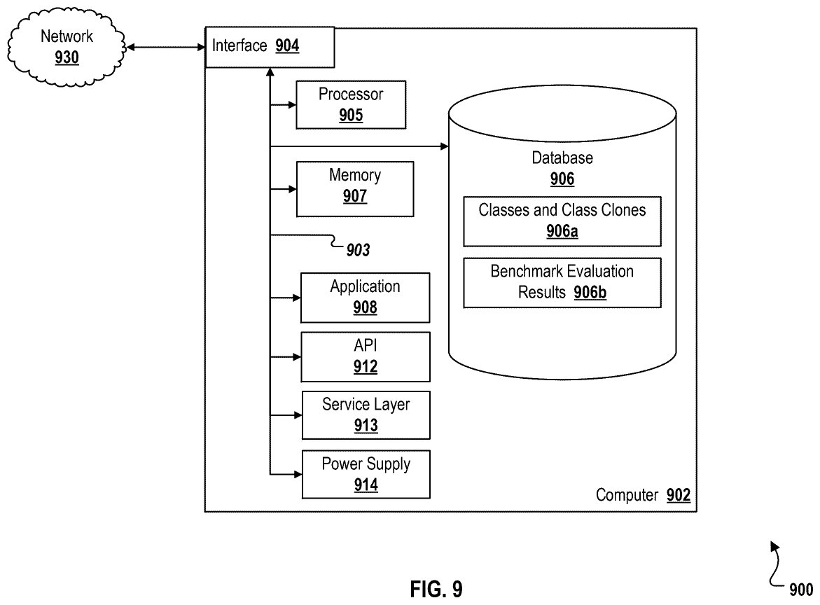

FIG. 9 is a block diagram illustrating an example of a computer-implemented System 900 used to provide computational functionalities associated with described algorithms, methods, functions, processes, flows, and procedures, according to an implementation of the present disclosure. In the illustrated implementation, computer-implemented system 900 includes a Computer 902 and a Network 930.

The illustrated Computer 902 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 902 can include an input device, such as a keypad, keyboard, or touch screen, or a combination of input devices that can accept user information, and an output device that conveys information associated with the operation of the Computer 902, including digital data, visual, audio, another type of information, or a combination of types of information, on a graphical-type user interface (UI) (or GUI) or other UI.

The Computer 902 can serve in a role in a distributed computing system as, for example, a client, network component, a server, or a database or another persistency, or a combination of roles for performing the subject matter described in the present disclosure. The illustrated Computer 902 is communicably coupled with a Network 930. In some implementations, one or more components of the Computer 902 can be configured to operate within an environment, or a combination of environments, including cloud-computing, local, or global.

At a high level, the Computer 902 is an electronic computing device operable to receive, transmit, process, store, or manage data and information associated with the described subject matter. According to some implementations, the Computer 902 can also include or be communicably coupled with a server, such as an application server, e-mail server, web server, caching server, or streaming data server, or a combination of servers.

The Computer 902 can receive requests over Network 930 (for example, from a client software application executing on another Computer 902) and respond to the received requests by processing the received requests using a software application or a combination of software applications. In addition, requests can also be sent to the Computer 902 from internal users (for example, from a command console or by another internal access method), external or third-parties, or other entities, individuals, systems, or computers.

Each of the components of the Computer 902 can communicate using a System Bus 903. In some implementations, any or all of the components of the Computer 902, including hardware, software, or a combination of hardware and software, can interface over the System Bus 903 using an application programming interface (API) 912, a Service Layer 913, or a combination of the API 912 and Service Layer 913. The API 912 can include specifications for routines, data structures, and object classes. The API 912 can be either computer-language independent or dependent and refer to a complete interface, a single function, or even a set of APIs. The Service Layer 913 provides software services to the Computer 902 or other components (whether illustrated or not) that are communicably coupled to the Computer 902. The functionality of the Computer 902 can be accessible for all service consumers using the Service Layer 913. Software services, such as those provided by the Service Layer 913, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 902, alternative implementations can illustrate the API 912 or the Service Layer 913 as stand-alone components in relation to other components of the Computer 902 or other components (whether illustrated or not) that are communicably coupled to the Computer 902. Moreover, any or all parts of the API 912 or the Service Layer 913 can be implemented as a child or a sub-module of another software module, enterprise application, or hardware module without departing from the scope of the present disclosure.

The Computer 902 includes an Interface 904. Although illustrated as a single Interface 904, two or more Interfaces 904 can be used according to particular needs, desires, or particular implementations of the Computer 902. The Interface 904 is used by the Computer 902 for communicating with another computing system (whether illustrated or not) that is communicatively linked to the Network 930 in a distributed environment. Generally, the Interface 904 is operable to communicate with the Network 930 and includes logic encoded in software, hardware, or a combination of software and hardware. More specifically, the Interface 904 can include software supporting one or more communication protocols associated with communications such that the Network 930 or hardware of Interface 904 is operable to communicate physical signals within and outside of the illustrated Computer 902.

The Computer 902 includes a Processor 905. Although illustrated as a single Processor 905, two or more Processors 905 can be used according to particular needs, desires, or particular implementations of the Computer 902. Generally, the Processor 905 executes instructions and manipulates data to perform the operations of the Computer 902 and any algorithms, methods, functions, processes, flows, and procedures as described in the present disclosure.

The Computer 902 also includes a Database 906 that can hold data for the Computer 902, another component communicatively linked to the Network 930 (whether illustrated or not), or a combination of the Computer 902 and another component. For example, Database 906 can be an in-memory or conventional database storing data consistent with the present disclosure. In some implementations, Database 906 can be a combination of two or more different database types (for example, a hybrid in-memory and conventional database) according to particular needs, desires, or particular implementations of the Computer 902 and the described functionality. Although illustrated as a single Database 906, two or more databases of similar or differing types can be used according to particular needs, desires, or particular implementations of the Computer 902 and the described functionality. While Database 906 is illustrated as an integral component of the Computer 902, in alternative implementations, Database 906 can be external to the Computer 902. The Database 906 can hold and operate on at least any data type mentioned or any data type consistent with this disclosure. For example, the Database 906 includes classes and class clones 906a and benchmark evaluation results 906b.

The Computer 902 also includes a Memory 907 that can hold data for the Computer 902, another component or components communicatively linked to the Network 930 (whether illustrated or not), or a combination of the Computer 902 and another component. Memory 907 can store any data consistent with the present disclosure. In some implementations, Memory 907 can be a combination of two or more different types of memory (for example, a combination of semiconductor and magnetic storage) according to particular needs, desires, or particular implementations of the Computer 902 and the described functionality. Although illustrated as a single Memory 907, two or more Memories 907 or similar or differing types can be used according to particular needs, desires, or particular implementations of the Computer 902 and the described functionality. While Memory 907 is illustrated as an integral component of the Computer 902, in alternative implementations, Memory 907 can be external to the Computer 902.

The Application 908 is an algorithmic software engine providing functionality according to particular needs, desires, or particular implementations of the Computer 902, particularly with respect to functionality described in the present disclosure. For example, Application 908 can serve as one or more components, modules, or applications. Further, although illustrated as a single Application 908, the Application 908 can be implemented as multiple Applications 908 on the Computer 902. In addition, although illustrated as integral to the Computer 902, in alternative implementations, the Application 908 can be external to the Computer 902.

The Computer 902 can also include a Power Supply 914. The Power Supply 914 can include a rechargeable or non-rechargeable battery that can be configured to be either user-or non-user-replaceable. In some implementations, the Power Supply 914 can include power-conversion or management circuits (including recharging, standby, or another power management functionality). In some implementations, the Power Supply 914 can include a power plug to allow the Computer 902 to be plugged into a wall socket or another power source to, for example, power the Computer 902 or recharge a rechargeable battery.

There can be any number of Computers 902 associated with, or external to, a computer system containing Computer 902, each Computer 902 communicating over Network 930. Further, the term “client,” “user,” or other appropriate terminology can be used interchangeably, as appropriate, without departing from the scope of the present disclosure. Moreover, the present disclosure contemplates that many users can use one Computer 902, or that one user can use multiple computers 902.

Described implementations of the subject matter can include one or more features, alone or in combination.

For example, in a first implementation, a computer-implemented method includes identifying a first code artifact for a first artificial intelligence (AI) benchmark task. An executable version of the first code artifact is configured to run in a first execution context. A first portion of code for the first AI benchmark task is determined in a first copy of the first code artifact. A second copy of the first code artifact is automatically generated by automatically replacing, in the first copy of the first code artifact, the first portion of code for the first AI benchmark task with a first fill-in marker for AI code generation. A first prompt and at least a portion of the second copy of the first code artifact are provided to a first AI model. The first prompt instructs the first AI model to generate code to replace the first fill-in marker. First model-generated code is received from the first AI model. A third copy of the first code artifact is automatically generated by automatically replacing, in the second copy of the first code artifact, the first fill-in marker with the first model-generated code. Code generation of the first AI model is automatically evaluated by automatically evaluating the third copy of the first code artifact, including executing an executable version of the third copy of the first code artifact in a second execution context that is equivalent to the first execution context.

In a second implementation, a non-transitory, computer-readable medium stores one or more instructions executable by a computer system to perform one or more operations. The operations include identifying a first code artifact for a first artificial intelligence (AI) benchmark task. An executable version of the first code artifact is configured to run in a first execution context. A first portion of code for the first AI benchmark task is determined in a first copy of the first code artifact. A second copy of the first code artifact is automatically generated by automatically replacing, in the first copy of the first code artifact, the first portion of code for the first AI benchmark task with a first fill-in marker for AI code generation. A first prompt and at least a portion of the second copy of the first code artifact are provided to a first AI model. The first prompt instructs the first AI model to generate code to replace the first fill-in marker. First model-generated code is received from the first AI model. A third copy of the first code artifact is automatically generated by automatically replacing, in the second copy of the first code artifact, the first fill-in marker with the first model-generated code. Code generation of the first AI model is automatically evaluated by automatically evaluating the third copy of the first code artifact, including executing an executable version of the third copy of the first code artifact in a second execution context that is equivalent to the first execution context.

In a third implementation, A computer-implemented system comprises one or more computers and one or more computer memory devices interoperably coupled with the one or more computers and having tangible, non-transitory, machine-readable media storing one or more instructions that, when executed by the one or more computers, perform one or more operations. The operations include identifying a first code artifact for a first artificial intelligence (AI) benchmark task. An executable version of the first code artifact is configured to run in a first execution context. A first portion of code for the first AI benchmark task is determined in a first copy of the first code artifact. A second copy of the first code artifact is automatically generated by automatically replacing, in the first copy of the first code artifact, the first portion of code for the first AI benchmark task with a first fill-in marker for AI code generation. A first prompt and at least a portion of the second copy of the first code artifact are provided to a first AI model. The first prompt instructs the first AI model to generate code to replace the first fill-in marker. First model-generated code is received from the first AI model. A third copy of the first code artifact is automatically generated by automatically replacing, in the second copy of the first code artifact, the first fill-in marker with the first model-generated code. Code generation of the first AI model is automatically evaluated by automatically evaluating the third copy of the first code artifact, including executing an executable version of the third copy of the first code artifact in a second execution context that is equivalent to the first execution context.

The foregoing and other described implementations can each, optionally, include one or more of the following features:
A first feature, combinable with any of the following features, wherein the first code artifact is a class or a program.
A second feature, combinable with any of the previous or following features, wherein the first code artifact is an Advanced Business Application Programming (ABAP) class or an ABAP program.
A third feature, combinable with any of the previous or following features, wherein the first portion of code for the first AI benchmark task is delimited by a predetermined benchmark task start marker and a predetermined benchmark task end marker.
A fourth feature, combinable with any of the previous or following features, wherein the first portion of code for the first AI benchmark task comprises a reference implementation for the first AI benchmark task.
A fifth feature, combinable with any of the previous or following features, wherein the first execution context and the second execution context each include an availability of a same set of external resources that are external to the first code artifact and are available to be used by the executable version of the first code artifact and the executable version of the third copy of the first code artifact.
A sixth feature, combinable with any of the previous or following features, wherein the reference implementation and the first model-generated code each include a reference to a same external resource.
A seventh feature, combinable with any of the previous or following features, wherein automatically evaluating the third copy of the first code artifact includes determining whether the third copy of the first code artifact can be successfully deserialized.
An eighth feature, combinable with any of the previous or following features, wherein automatically evaluating the third copy of the first code artifact includes performing a syntax check of the third copy of the first code artifact and determining whether the syntax check is successful.
A ninth feature, combinable with any of the previous or following features, wherein executing the executable version of the third copy of the first code artifact in the second execution context comprises identifying at least one unit test for the first AI benchmark task and executing each identified unit test for the first AI benchmark task, wherein executing each unit test comprises executing an executable version of the first model-generated code and evaluating the execution of the executable version of the first model-generated code.
A tenth feature, combinable with any of the previous or following features, wherein information is provided for other code artifact copies for other AI benchmark tasks to the first AI model and code generated by the first AI model is automatically evaluated for the other AI benchmark tasks.
An eleventh feature, combinable with any of the previous or following features, wherein AI code generation metrics are determined for the first AI model based on automatic evaluation of the third copy of the first code artifact and automatic evaluation of the code generated by the first AI model for the other AI benchmark tasks.
A twelfth feature, combinable with any of the previous or following features, wherein information is provided for the third copy of the first code artifact and for other code artifact copies for the other benchmark tasks to one or more other AI models and code generated by the one or more other AI models is automatically evaluated.
A thirteenth feature, combinable with any of the previous or following features, wherein cross-model code generation metrics are determined for the first AI model and the one or more other AI models.
A fourteenth feature, combinable with any of the previous or following features, wherein a dashboard is generated that presents code generation metrics for a given AI model, the cross-model code generation metrics, and a view that includes, for a given AI benchmark task and a given AI model, generated code generated by the AI model and a reference implementation for the given AI benchmark task.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
identifying a first code artifact for a first artificial intelligence (AI) benchmark task, wherein an executable version of the first code artifact is configured to run in a first execution context;
determining, in a first copy of the first code artifact, a first portion of code for the first AI benchmark task;
automatically generating a second copy of the first code artifact by automatically replacing, in the first copy of the first code artifact, the first portion of code for the first AI benchmark task with a first fill-in marker for AI code generation;
providing a first prompt and at least a portion of the second copy of the first code artifact to a first AI model, wherein the first prompt instructs the first AI model to generate code to replace the first fill-in marker;
receiving, from the first AI model, first model-generated code;
automatically generating a third copy of the first code artifact by automatically replacing, in the second copy of the first code artifact, the first fill-in marker with the first model-generated code; and
automatically evaluating code generation of the first AI model by automatically evaluating the third copy of the first code artifact, including executing an executable version of the third copy of the first code artifact in a second execution context that is equivalent to the first execution context.

2. The computer-implemented method of claim 1, wherein the first code artifact is a class or a program.

3. The computer-implemented method of claim 2, wherein the first code artifact is an Advanced Business Application Programming (ABAP) class or an ABAP program.

4. The computer-implemented method of claim 1, wherein the first portion of code for the first AI benchmark task is delimited by a predetermined benchmark task start marker and a predetermined benchmark task end marker.

5. The computer-implemented method of claim 1, wherein the first portion of code for the first AI benchmark task comprises a reference implementation for the first AI benchmark task.

6. The computer-implemented method of claim 5, wherein the first execution context and the second execution context each include an availability of a same set of external resources that are external to the first code artifact and are available to be used by the executable version of the first code artifact and the executable version of the third copy of the first code artifact.

7. The computer-implemented method of claim 6, wherein the reference implementation and the first model-generated code each include a reference to a same external resource.

8. The computer-implemented method of claim 1, wherein automatically evaluating the third copy of the first code artifact includes determining whether the third copy of the first code artifact can be successfully deserialized.

9. The computer-implemented method of claim 1, wherein automatically evaluating the third copy of the first code artifact includes performing a syntax check of the third copy of the first code artifact and determining whether the syntax check is successful.

10. The computer-implemented method of claim 1, wherein executing the executable version of the third copy of the first code artifact in the second execution context comprises:
identifying at least one unit test for the first AI benchmark task; and
executing each identified unit test for the first AI benchmark task, wherein executing each unit test comprises executing an executable version of the first model-generated code and evaluating the execution of the executable version of the first model-generated code.

11. The computer-implemented method of claim 1, further comprising:
providing information for other code artifact copies for other AI benchmark tasks to the first AI model; and
automatically evaluating code generated by the first AI model for the other AI benchmark tasks.

12. The computer-implemented method of claim 11, further comprising determining AI code generation metrics for the first AI model based on automatic evaluation of the third copy of the first code artifact and automatic evaluation of the code generated by the first AI model for the other AI benchmark tasks.

13. The computer-implemented method of claim 12, further comprising:
providing information for the third copy of the first code artifact and for other code artifact copies for the other benchmark tasks to one or more other AI models;
and automatically evaluating code generated by the one or more other AI models.

14. The computer-implemented method of claim 13, further comprising determining cross-model code generation metrics for the first AI model and the one or more other AI models.

15. The computer-implemented method of claim 14, further comprising generating a dashboard that presents code generation metrics for a given AI model, the cross-model code generation metrics, and a view that includes, for a given AI benchmark task and a given AI model, generated code generated by the AI model and a reference implementation for the given AI benchmark task.

16. A non-transitory, computer-readable medium storing one or more instructions executable by a computer system to perform one or more operations, comprising:
identifying a first code artifact for a first artificial intelligence (AI) benchmark task, wherein an executable version of the first code artifact is configured to run in a first execution context;
determining, in a first copy of the first code artifact, a first portion of code for the first AI benchmark task;
automatically generating a second copy of the first code artifact by automatically replacing, in the first copy of the first code artifact, the first portion of code for the first AI benchmark task with a first fill-in marker for AI code generation;
providing a first prompt and at least a portion of the second copy of the first code artifact to a first AI model, wherein the first prompt instructs the first AI model to generate code to replace the first fill-in marker;
receiving, from the first AI model, first model-generated code;
automatically generating a third copy of the first code artifact by automatically replacing, in the second copy of the first code artifact, the first fill-in marker with the first model-generated code; and
automatically evaluating code generation of the first AI model by automatically evaluating the third copy of the first code artifact, including executing an executable version of the third copy of the first code artifact in a second execution context that is equivalent to the first execution context.

17. The computer-readable medium of claim 16, wherein the first execution context and the second execution context include an availability of a same set of external resources that are external to the first code artifact and are available to be used by the executable version of the first code artifact and the executable version of the third copy of the first code artifact.

18. The computer-readable medium of claim 16, wherein the first code artifact is an Advanced Business Application Programming (ABAP) class or an ABAP program.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
identifying a first code artifact for a first artificial intelligence (AI) benchmark task, wherein an executable version of the first code artifact is configured to run in a first execution context;
determining, in a first copy of the first code artifact, a first portion of code for the first AI benchmark task;
automatically generating a second copy of the first code artifact by automatically replacing, in the first copy of the first code artifact, the first portion of code for the first AI benchmark task with a first fill-in marker for AI code generation;
providing a first prompt and at least a portion of the second copy of the first code artifact to a first AI model, wherein the first prompt instructs the first AI model to generate code to replace the first fill-in marker;
receiving, from the first AI model, first model-generated code;
automatically generating a third copy of the first code artifact by automatically replacing, in the second copy of the first code artifact, the first fill-in marker with the first model-generated code; and
automatically evaluating code generation of the first AI model by automatically evaluating the third copy of the first code artifact, including executing an executable version of the third copy of the first code artifact in a second execution context that is equivalent to the first execution context.

20. The computer-implemented system of claim 19, wherein the first execution context and the second execution context include an availability of a same set of external resources that are external to the first code artifact and are available to be used by the executable version of the first code artifact and the executable version of the third copy of the first code artifact.
